(19) United States
(12) Patent Application Publication
(10) Pub. No.: US 2023/0056123 A1
(43) Pub. Date: Feb. 23, 2023

(54) CURABLE CASTING COMPOUND FOR THE MANUFACTURE OF MOLDED PLASTICS

(71) Applicant: BLANCO GMBH + CO KG, Oberderdingen (DE)

(72) Inventor: Andreas HAJEK, Weingarten (DE)

(73) Assignee: BLANCO GMBH + CO KG, Oberderdingen (DE)

(21) Appl. No.: 17/883,907

(22) Filed: Aug. 9, 2022

(30) Foreign Application Priority Data
Aug. 11, 2021 (DE) 10 2021 208 803.1

(51) Int. Cl. C08K 11/00; C08K 3/36

(52) U.S. Cl. CPC C08K 11/00; C08K 3/36

(57) ABSTRACT

This invention relates to a curable casting compound for the manufacture of molded plastics, comprising a casting compound having a binder composition and a filler composition, wherein the filler composition has at least a first portion of an inorganic filler and a second portion of an organic filler, wherein the second portion of organic filler comprises comminuted nutshells—as a nutshell portion, in particular granular nutshells, having a percentage by weight of 1% by wt. to 100% by wt. of the filler composition.

The invention relates to a curable casting compound for the production of molded plastics, comprising a casting compound having a binder composition and a filler composition, wherein the filler composition comprises at least a first portion of inorganic filler and a second portion of organic filler.

The invention further relates to a use of a curable casting compound.

The invention further relates to a molded plastic made using a curable casting compound.

Curable casting compounds are used for the manufacture of molded plastics, especially in the sanitary or kitchen sector, such as kitchen sinks, countertops, bathtubs, washbasins or the like. The curable casting compounds usually comprise a binder material and a filler material to improve the mechanical properties and optical structures of the molded plastics, as is known, for instance, from DE 38 32 351 A1 or WO 2005/071000 A1.

From DE 10 2019 125 777 A1, moreover, a thermosetting bio-based casting compound is known, comprising one or more monofunctional and one or more polyfunctional acrylic and/or methacrylic biomonomers of plant or animal origin, one or more polymers or copolymers selected from polyacrylates, polymethacrylates, polyols, polyesters of recycled material or of plant or animal origin, and inorganic filler particles of natural origin, wherein the proportion of the mono- and polyfunctional acrylic and methacrylic biomonomer(s) is 10-40% by wt., the proportion of the polymer(s) or copolymer(s) is 1-16% by wt. and the proportion of the inorganic filler particles is 44-89% by wt.

WO 2021/145472 A1 further discloses an environmentally friendly artificial marble, the natural beauty of which can be enhanced by adding pulverized grain husks or fruit peels, and a method for the production of this artificial marble. Such artificial marble is manufactured using an unsaturated polyester resin or an acrylic resin and comprises 5-80 parts by weight of grain husk powder, in relation to 100 parts by weight of the unsaturated polyester resin or the acrylic resin, wherein 10-100 parts by weight of one or more low-profile thermoplastic additives selected from PS, PE and PVAc, 200-300 parts by weight of aluminum hydroxide as an inorganic filler, 10-100 parts by weight of color chips, 5-100 parts by weight of polyvinyl alcohol fiber as a reinforcing material, 1-5 parts by weight of an organic peroxide as a curing catalyst, and 5-30 parts by weight of a mold release agent are added as additives in relation to 100 parts by weight of the unsaturated polyester resin or the acrylic resin.

The disadvantage of such a molded plastic is its high weight and poor cleanability.

Therefore this invention addresses the problem of providing an alternative curable casting compound and a molded plastic made therefrom that feature an improved ease of cleaning or cleanability and, simultaneously, lower weight.

This invention solves the problem for a curable casting compound for the manufacture of molded plastics, comprising a casting compound having a binder composition and a filler composition, wherein the filler composition has at least a first portion of an inorganic filler and a second portion of an organic filler, in that the second portion of organic filler comprises comminuted nutshells—a nutshell portion, in particular granular nutshells, having a percentage by weight of 1% by wt. to 100% by wt. of the filler composition.

This invention also solves the problem by using the curable casting compound according to any one of claims 1 to 10 for the manufacture of a molded plastic for the kitchen and/or sanitary sector, in particular kitchen sinks and countertops for kitchens.

This invention also solves the problem by means of a molded plastic manufactured using the curable casting compound according to any one of the claims 1 to 10.

This invention also solves the problem by using crushed nutshells for improving the cleaning properties in molded plastics, in particular with a percentage by weight of a casting compound of the molded plastics comprising a filler composition and a binder composition with a percentage by weight of 1% by wt. to 100% by wt. of the filler composition.

One of the advantages achieved is that the cleanability of surfaces of molded plastics can be improved in the following manner: by using an organic filler in the form of crushed nutshells instead of the standard inorganic filler, it was found to everyone's surprise that cleanability was significantly improved. In addition, nutshells are from a source of renewable raw materials, resulting in an overall reduced carbon footprint and reduced consumption of petrochemically produced materials.

The term “nut” is defined in the broadest sense and means, in particular in the description, preferably in the claims, achenes, in which in particular all three layers of the pericarp are lignified, or drupes. In most cases, only one single seed, colloquially also referred to as a nut, is enclosed in the nutshell. The term “nut” also includes kernels of fruit, in particular nuts and seeds. The term “nut” as used in this invention includes, for example;

Beechnuts,

Chilean hazelnut,

True walnut (Juglans regia),

European chestnut (Maroni),

Acorn,

Peanut (Arachis hypogaea),

Hemp nut,

Hazelnut,

Macadamia nut (Queensland nut),

Plane tree fruit,

Stone Nut (Tagus),

Water nut,

Cashew nut,

Tiger nut (chufa),

Coconut,

Kola nut,

Almond,

Nutmeg,

Brazil nut

Pecan,

Pili nut,

Pistachio, and/or

Shea nut.

Further features, advantages and further embodiments of the invention are described below or become apparent.

According to a preferred embodiment of the invention, the nut shell content comprises 20% by wt. to 80% by wt., in particular 40% by wt. to 60% by wt. of the filler composition. In this way, the proportion of renewable raw material is rather high on the one hand, while at the same time good cleanability and a low weight of a molded plastic is achieved.

According to a further preferred embodiment of the invention, the nutshell portion has at least a portion, in particular consists completely, of granular nutshells having an average diameter d₅₀ relative to the weight of 200 to 10,000 μm, in particular 400 to 5,000 μm, preferably 500 to 1,000 μm. The advantage thereof is a good homogenization of the nutshells in the casting compound.

According to a further preferred embodiment of the invention, the nutshell portion has several portions of differing mean diameters 50 relative to the weight. In this way, homogeneity and at the same time cleanability can be flexibly adapted to the respective compositions of the casting compound.

According to a further preferred embodiment of the invention, the nut shells comprise hazelnut shells and/or walnut shells, in particular predominantly walnut shells. In this way, a cost-effective and easy availability of the nutshells is ensured.

According to a further preferred embodiment of the invention, the first portion of inorganic filler comprises quartz sand. The advantage thereof is the availability of the quartz sand as a low-cost filler, which also provides sufficient temperature resistance and scratch resistance for a molded plastic produced from the casting compound.

According to a further preferred embodiment of the invention, the binder composition comprises at least a portion of at least one citrus fruit—as a citrus fruit portion, in particular of its peel, The advantage thereof is a reduction of the usually high proportion of petrochemical components in the binder composition.

According to a further preferred embodiment of the invention, the citrus fruit content relative to the binder composition is 0.1% by wt. to 10% by wt., in particular 0.2% by wt. to 5% by wt., preferably 0.2% by wt. to 5% by wt. The advantage thereof is a sufficient curing of molded plastics produced by means of the casting compound.

According to a further preferred embodiment of the invention, the citrus fruit portion comprises the ingredient D-limonene and/or L-limonene and/or D,L-limonene. It/they make(s) for a sufficient curing of molded plastics produced by means of the casting compound in a reliable manner.

According to a further preferred embodiment of the invention, the binder composition comprises at least a portion of a liquid monomeric acrylate. The advantage thereof is that it can be polymerized to a polyacrylate during the manufacture of a molded plastic while curing. To increase the viscosity of the curable casting compound, a proportion of a pre-polymerized acrylate component can be added to the monomeric acrylate, for instance, pre-polymerized polymethyl methacrylate PMMA can be added to the monomeric methyl methacrylate.

Further important features and advantages of the invention are described in more detail in the dependent claims and in the explanation below.

It goes without saying that the features mentioned above and those to be explained below can be used not only in the combination indicated in each case, but also in other combinations or on their own, without departing from the scope of this invention.

Preferred designs and embodiments of the invention are explained in more detail in the description below.

It was found that the use of crushed nutshells in molded plastics according to the invention, in particular having a percentage by weight of a casting compound of the molded plastics comprising a filler composition and a binder composition having a percentage by weight of 1% by wt, to 100% by wt. of the filler composition, makes for an improved cleanability and a lower density and, consequently, a lower weight, in addition to improved environmental sustainability.

### COMPARATIVE EXAMPLE

A curable casting compound is manufactured by adding a filler composition to a binder composition. The binder composition is essentially obtained by dissolving PMMA in MMA, wherein a demolding agent and crosslinking monomers are added. A binder syrup is obtained in that way.

The filler material comprises granular quartz material Granucol® (Gebrüder Dorfner GmbH & Co., Hirschau) and wollastonite (Quarzwerke, Frechen). The types of Granucol ® and wollastonite listed below were used:
Granucol® white 2/9 (particle size 315 to 630 μm) and
Wollastonite (average needle length 5 to 11 μm)

A particularly attractive granite decor appearance can be achieved by using different

Granucol® grades, especially those having different colors. The addition of wollastonite improves the mechanical properties of the molded plastics that can be produced using the curable casting compound and, in particular, reduces the occurrence of so-called boil-outs on the backs of the moldings that can occur because of local overheating during the curing process, The advantages of using wollastonite are described in EP 1 207 180 A1, which is hereby incorporated by explicit reference.

The filler composition is now added to the binder material and homogeneously mixed therewith. A coloring material composition can also be added to the curable casting compound to adjust the desired color of the subsequent molded plastics.

The casting compound is then thermally cured by means of free-radical polymerization.

In addition, the binder composition may also comprise one or more cross-linking agents. Cross-linking agents are, for instance, substances from the group of aliphatic or aromatic di-, tri- or multifunctional acylates or methacrylates and/or epoxy acrylates or methacrylates and/or aliphatic or aromatic di-, tri- or multifunctional urethane acrylates or methacrylates and/or di-, tri- or multifunctional polyester acylates or methacrylates and/or di-, tri- or multifunctional silicone acrylates or methacrylates, silicone urethane acrylates or methacrylates and silicone polyester acrylates or methacrylates, or combinations thereof.

The composition of the curable casting compound according to the comparative example is again shown in general form in Table 1 below, wherein the contents of the individual components are specified in percent by weight.

TABLE 1

| | Comparative example |
|---|---|
| Formulation designation | [% by wt.] |
| Binder (PMMA in MMA) | 41.1 |
| Trimethylpropane trimethacylate | 0.9 |
| Peroxide mixture | 1.0 |
| Granucol ® white 2/9 | 55.0 |
| Wollastonite | 2.0 |
| Total | 100.0 |

As mentioned above, the curable casting compound is then placed in a casting mold for a kitchen sink and polymerized by being exposed to heat.

Various chemicals and foods were now applied to a visible side of a kitchen sink obtained in this way, and each was left to act for 16 hours.

| | Stains still present after: | | |
|---|---|---|---|
| | Rinsing using | Cleaning using | Cleaning using |
| Sample | distilled water | water | Alumina |
| Comparative | Methylene blue | Methylene blue | — |
| example | black tea | (weak) | — |

| | Soot contamination |
|---|---|
| Sample | Cleanability - revolutions |
| Comparative example | 20/30 |

| | Density (Accupyk) |
|---|---|
| Sample | [g/cm³] |
| Comparative example | 2.0 |

A cleaning device having a contact weight of 1 kg and 30 rpm using water or Alumina was used for cleaning.

### EXAMPLE

A casting compound according to the invention, the composition of which largely matches that of the curable casting compound according to the comparative example, wherein an amount of nutshell granules is added in exchange for a matching amount of Granucol® white 2/9. In addition, an amount of binder was removed in exchange for an equivalent amount of D,L-limonene. The remaining amounts of materials are kept the same.

The composition of the curable casting compound in accordance with the example is shown in Table 2 below, wherein the contents of the individual components are specified in percent by weight, in each case in relation to 100kg of curable casting compound.

TABLE 2

| | Example |
|---|---|
| Formulation designation | [% by wt.] |
| Binder (PMMA in MMA) | 39.6 |
| Trimethyipropane trimethacrylate | 0.9 |
| Peroxide mixture | 1.0 |
| D,L limonene | 1.5 |
| Nutshell granules 450-800 | 15.0 |
| Nutshell granules 450-1000 | 15.0 |
| Granucol ® white 2/9 | 25.0 |
| Wollastonite | 2.0 |
| Total | 100.0 |

Various chemicals and foods were then applied to a visible side of a kitchen sink obtained in this way, and each was left to act for 16 hours.

Stains still present after:

| | Rinsing using | Cleaning using | Cleaning using |
|---|---|---|---|
| Sample | distilled water | water | Alumina |
| Example | none | — | — |

| | Soot contamination |
|---|---|
| Sample | Cleanability - revolutions |
| Example | 10/10 |

| | Density (Accupyk) |
|---|---|
| Sample | [g/cm³] |
| Example | 1.37 |

A cleaning device having a contact weight of 1 kg and 30 rpm using water or Alumina was used for cleaning. When checking cleanability on the basis of soot contamination, two tests each were performed using the comparative example and the example. The number of revolutions was increased until the identical optical result was obtained in every case.

As a result, it shall be noted that for the same cleaning procedure it was easier to remove the soiling in the example as compared to the comparative example, i.e.

fewer revolutions of the cleaning device were required until a complete removal of the soot soiling was achieved. Finally, based on the determination of the respective weights of the kitchen sinks and their volumes or a corresponding comparable test specimen, a lower density was achieved for the example, compared to the comparative example.

The results thus show that replacing organic petrochemical fillers with granular nutshells in the curable casting compound results in a significant improvement in cleanability.

The kitchen sinks produced using the curable casting compound according to one embodiment of this invention have a lower weight or density and improved cleanability compared to the curable casting compound obtained in the comparative example.

I.e., the effect of improved cleanability occurs with the use of crushed nutshells according to the invention.

In summary, at least one embodiment of this invention provides at least one of the advantages listed below and/or provides at least one of the features listed below:
Improved cleanability of the surface of molded plastics.
Improved environmental compatibility, in particular lower CO2 generation during manufacture.
High flexibility with regard to the visual design of surfaces.

Although this invention has been described with reference to preferred exemplary embodiments, it is not limited thereto and can be modified in a variety of ways.

1. A curable casting compound for the manufacture of molded plastics comprising a casting compound having a binder composition and a filler composition, wherein the filler composition has at least one inorganic filler and at least one organic filler, characterized in that the organic filler comprises comminuted nutshells as a nutshell portion, in particular granular nutshells, having a percentage by weight from 1% by wt. to 100% by wt. of the filler composition.

2. The curable casting compound according to claim 1, characterized in that the nutshell portion comprises 20% by wt. to 80% by wt., in particular 40% by wt. to 60% by wt. of the filler composition.

3. The curable casting compound according to claim 1, characterized in that the nutshell portion has at least one portion consisting of granular nutshells having an average diameter d₅₀ relative to a weight of 200 to 10,000 μm, in particular 400 to 5,000 μm, preferably 500 to 1,000 μm.

4. The curable casting compound according to claim 3, characterized in that the nutshell portion has at least two portions of differing mean diameters d₅₀ relative to weight.

5. The curable casting compound according to claim 1, characterized in that the nutshell portions comprise hazelnut shells and/or walnut shells, in particular predominantly walnut shells.

6. The curable casting compound according to claim 1, characterized in that the at least one inorganic filler comprises quartz sand.

7. The curable casting compound according to claim 1, characterized in that the binder composition comprises at least one portion of at least one citrus fruit as citrus fruit portion, in particular of a peel of a citrus fruit.

8. The curable casting compound according to claim 7, characterized in that the content of citrus fruit portion relative to the binder composition is 0.1% by wt. to 10% by wt., in particular 0.2% by wt. to 5% by wt., preferably 0.2% by wt. to 5% by wt.

9. A curable casting compound according to claim 7, characterized in that the citrus fruit portion comprises the ingredient D-limonene and/or L-limonene and/or D,L-limonene.

10. The curable casting compound according to claim 1, characterized in that the binder composition comprises at least one portion of a liquid monomeric acrylate.

11. Use of a curable casting compound according to claim 1, for the manufacture of a molded plastic for the kitchen and/or sanitary sector, in particular kitchen sinks and countertops for kitchens.

12. A molded plastic manufactured using the curable molding mass according to claim 1.

13. Use of crushed nutshells for improving the cleaning properties of molded plastics, in particular having a percentage by weight of a casting compound of the molded plastics comprising a filler composition and a binder composition with a percentage by weight of 1% by wt. to 100% by wt. of the filler composition.
